(19) United States
(12) Patent Application Publication
(10) Pub. No.: US 2005/0228895 A1
(43) Pub. Date: Oct. 13, 2005

(54) Method, Web service gateway (WSG) for presence, and presence server for presence information filtering and retrieval

(76) Inventors: Rajesh Karunamurthy, Brossard (CA); Ferhat Khendek, Montreal (CA); Roch Glitho, Montreal (CA)

Correspondence Address: Alex Nicolaescu;Ericsson Canada Inc., Patent Department, 8400 Decarie Blvd., Town Mount Royal, QC, H4P 2N2, CA

(21) Appl. No.: 10/811,821

(22) Filed: Mar. 30, 2004

(51) Int. Cl. G06F 15/16

(52) U.S. Cl. 709/229

(57) ABSTRACT

A method, a Web Service Gateway (WSG) for presence, and a presence server that responsive to a request for presence information received from a watcher, filters the presence information of a plurality of presence entities based on one or more criteria received from the watcher in the request, and respond back to the watcher only with the presence information of those presence entities that match the desired criteria. The request may comprise identification of a plurality of presence entities. In a first variant, the WSG for presence, which interfaces with the presence server, obtains the presence information of the plurality of presence entities from the server, filters them, and returns to the watcher the presence information of the presence entities matching the criteria. In a second variant, the presence server receives the request, performs the filtering, and responds to the watcher with the presence information of the matching presence entities.

### BACKGROUND OF THE INVENTION

1. Field of the Invention

The present invention relates to a methods and systems for presence information retrieval.

2. Description of the Related Art

Web services (also called application services) are services that typically include a combination of programming and data made available from a business' Web server for Web users or other Web-connected programs. Providers of Web services are generally known as application service providers. Web services range from such major services as storage management and customer relationship management (CRM) down to much more limited services such as the provision of a stock quote, the checking of bids for an auction item or a weather forecast. Web Services are typically published in a central public repository, such as UDDI (Universal Description, Discovery and Integration), where they are dynamically found and bound by the service users.

Services previously possible only with the older standardized service known as Electronic Data Interchange (EDI) are likely to become Web services. Besides the standardization and wide availability to users and businesses of the Internet itself, Web services are also increasingly enabled by the use of the Extensible Mark-up Language (XML) as a means of standardizing data formats for exchanging data. XML, a formal recommendation of the World Wide Web Consortium (W3C), is the foundation for the Web Services Description Language (WSDL), and is a flexible way to create common information formats and share both format and data on the World Wide Web, intranets, and elsewhere. For example, computer makers might agree on a standard or common way to describe the information about a computer product (processor speed, memory size, and so forth) and then describe the product information format with XML. Such a standard way of describing data would enable a user to send an intelligent agent (a program) to each computer makers Web site, gather data, and then make a valid comparison. XML can be used by any individual, group of individuals, or companies that want to share information in a consistent way.

One of the most promising web services is Presence, which constitutes a key enabler for mobile applications. Presence information is becoming a natural part of many interesting services such as chat, presence enhanced phonebook, Push-to-Talk (PTT), etc. Presence enriches the communication experience for the user, who becomes able to know how and when a friend or colleague can be reached before taking contact. With Presence, the user can build personal contact lists and immediately see who is online. Presence may further allow services and applications, such as for example advertisement broadcast and news updates, to better target audience that is online, thus improving the efficiency of resources allocation within a given network while increasing service revenues for the operator. Conclusively, Presence provides key operator benefits, among which are new business opportunities and increased chargeable traffic through call completion driven by the presence functionality. Likewise, Presence is also foreseen as beneficial for the end-user, providing the subscribers the ability to see how and when friends or colleagues are available before communicating, and to share interest, mood, location and content with others.

The basic concept about Presence technology is to allow entities (fixed and mobile terminals) to disseminate and consume presence information such as for example presence status, communication means, priorities, preferences, terminal capability, willingness to communicate, location and others. Depending on the usage made of presence information, there are two different entities: first, the presence entity, herein also called the presentity, is the terminal that publishes presence information related to itself. An example of presence information being published by or on behalf of the presentity, may be:

| | |
|---|---|
| User name | John Doe |
| Type of terminal | mobile terminal |
| User identifier: | John.Doe@networkABC.com |
| Presence status | connected |
| Communication means | Sony Ericsson P900 |
| Terminal Capability | GPRS, GSM, WAP |
| Location | Cell-ID = 0008876, Area = Montreal, |
| | Canada |
| Willingness to Communicate | Unrestricted |

The other entity in Presence is the watcher, which is the consumer of presence information relative to a watched, or monitored presentity. A watcher may subscribe with a Presence server for presence information related to one or more presentities, and is notified of the presence information of these presentities.

In order to implement Presence, the Instant Messaging and Presence Protocol (IMPP) working group (WG) of the Internet Engineering Task Force (IETF) has been formed to develop an architecture and to standardize a protocol for Instant Messaging (IM) and Presence. IMPP has proposed a Presence model, Presence protocol requirements and an interoperability framework called CPIM (Common Presence and Instant Messaging). On the other hand, the SIP (Session Initiation Protocol) for Instant Messaging and Presence Leveraging Extensions (SIMPLE) working group has defined a protocol called SIMPLE for IM and Presence by extending and using the advantages of SIP. The SIMPLE protocol is compliant with the presence protocol requirements and also with CPIM, so that it can interwork with other CPIM-compliant presence protocols. SIMPLE supports both server-based and peer-to-peer based architectures. It inherits basic SIP mechanisms and capabilities, such as addressing, routing and authentication.

In the mobile (wireless) domain, the 3^{rd} Generation Partnership Project (3GPP) also works on standardization of the presence protocol and an Application Programming Interface (API) for the presence service in wireless domain. It is likely to adopt SIMPLE as a basic presence protocol and extend some of its features to fit in the 3GPP service architecture, as SIP is already adopted as a signaling protocol.

Reference is now made to FIG. 1 (Prior Art), which is a high-level network representation of a presence functionality implemented via a presence server 100. Also shown in FIG. 1 is a cellular network 102 that comprises a plurality of base stations 104 that service a variety of mobile terminals 106. The cellular network 102 connects via the Internet 108 to the presence server 100, so that mobile terminals 106 can benefit from Presence, i.e. to be able to publish their own presence information, or to subscribe for presence information of others. Further represented in FIG. 1 is an Internet Service Provider (ISP) 110 that provides Internet service to a plurality of fixed terminals 112. The ISP 110 is also connected to the presence server 100 via the Internet 108, thus allowing fixed terminals 112 to also be able to receive presence service from the presence server 100. Finally, also connected to the Internet 108 may be one or more Wide Area Networks (WAN) 120 or Local Area Networks (LAN) 122, each serving its respective end-users 124 and 126. The WAN 120 and the LAN 122 are also connected via the Internet 108 to the presence server 100, for enabling user terminals 124 and 126 to be able to receive presence service.

Presence service may be provided on a subscription basis, or as a punctual paid service. Any one of the end-user 106, 112, 124, and 126 may decide, at one point, to publish presence information about itself. For example the user of the laptop terminal 112 may subscribe to presence service with the presence server 100 and begin to publish presence information about itself, suing, for example a SIP Publish message 130. The message 130 may comprise an XML file containing presence information about the laptop terminal 112, as described hereinbefore. The message 130 is sent from the laptop 112 via the ISP 110 and the Internet 108 to the presence server 100, which receives the message and stores the presence information retrieved from message 130 in a presence database 140. By publishing presence information about itself, the laptop terminal 112 is considered to be a presence entity, or presentity. Another terminal, i.e. a watcher, may be interested in receiving presence information relative to terminal 112, and thus may subscribe to receive presence information related to the laptop terminal 112. For example, the user of the mobile PDA (Personal Digital Assistant) terminal 106 may desire to receive information as soon as the user of the laptop 112 becomes connected to the Internet in order to be able to send him an e-mail message and to be sure that the user of the laptop 112 receives, and is able to read the message on the spot. For this purpose, the PDA terminal 106 sends a subscription message such as for example a SIP Subscribe message 150 via the cellular network 102 and the Internet 108 to the presence server 100, which registers the interest of the PDA terminal 106 (the watcher) in receiving presence information related to the laptop terminal 112 (the presence entity). Responsive to the subscription message 150, the presence server 100 responds to the terminal 106 (the watcher) with presence information related to the presence entity 112 in message 160. The transmission 160 may be done on a punctual basis, i.e. as soon as receiving the subscribe message 150 at the presence server 100, or at periodic intervals.

Instances occur, however, when a watcher is interested in receiving presence information of more than one presence entity at a time. In such circumstances, the watcher must send one subscription message similar to the message 150 for each one of the presence entities of interest. Responsive to each such Subscribe message, the presence server 100 returns presence information related to each one of the presence entities of interest. When the number of presence entities is large, the signalling associated with requesting the presence information via multiple subscription messages, and the transmittal of presence information via corresponding plural responses becomes a substantial burden on the network resources.

Although there is no prior art solution as the one proposed hereinafter for solving the above-mentioned deficiencies, the U.S. patent application publication 2003/0110228 bears some relation with the field of the present invention. This publication teaches a collaboration workspace for multiparty problem resolution that monitors activity and presence in order to improve communication between network administrators and enhance the ability of service providers and end-users to work together to resolve issues concerning a user request or trouble tickets. Depending on the status of the user and service provider, a communication window provides communication via e-mail or instant messaging formats. However, the teaching of the publication U.S. patent application 2003/0110228 is limited to a method for joining users into multiparty communications sessions based on presence, and fails to address the issue of the manner in which the presence information is obtained for multiple presence entities at a time.

The U.S. patent application publication 2003/0041101 also bears some relation with the field of the present invention. This publication teaches a presence proxy that maintains presence information concerning a number of mobile units user agents and retains the presence information should the requesting user agent become unavailable. Further, the presence proxy provides lists of user agents about which particular user agent is interested in having presence information. The presence proxy also minimizes the number of notify messages sent to user agent. The U.S. patent application publication 2003/0041101 teaches a presence information proxy that allows a user agent of a watching entity to provide a single subscription request for a lists of presence entities, and that obtain in turn, within the same notify message, a list of presence information associated with each one of the entities.

Although the publication U.S. patent application 2003/0041101 provides for an improvement over the basic implementation of presence technology wherein presence information of one presence entity can only be requested by sending an individual subscription message, it still fails to teach a reliable manner in which presence information relative to a plurality of presence entities can be filtered down in order to properly fit the particular needs of a watcher. For example, a (commercial) watcher who may be a manager of a truck fleet, may be interested in receiving presence information related to a community of presence entities corresponding to his truck drivers. However, the fleet manager may be interested only in the presence information of truck drivers currently being located in the geographical area of Montreal, Canada. In such an instance, with the existing implementations, the watcher (the fleet manager) sends a subscription message comprising all the identities of the truck drivers' mobile terminals, and gets back the presence information of all truck drivers. From the list of the presence information received, the watcher, i.e. the fleet manager, further needs to manually identify which drivers are currently being located in Montreal, Canada. The current prior art implementations not only still waste network resources and bandwidth by transmitting much more presence information than the one actually needed by the watcher, but also puts an additional processing burden on the watcher itself for determining where, among all the received presence information, resides the presence information of actual interest.

Accordingly, it should be readily appreciated that in order to overcome the deficiencies and shortcomings of the existing solutions, it would be advantageous to have a method and system that renders the exchange of Presence information simpler and more efficient, especially when a watcher desires to receive presence information related to plural presence entities that satisfy certain criteria. The present invention provides such a method and system.

### SUMMARY OF THE INVENTION

In one aspect, the present invention is a A method for obtaining presence information comprising the steps of:
a. receiving a request for presence information, the request comprising an indication of one or more criteria associated with presence entities;
b. retrieving presence information for each one of a plurality of presence entities; and
c. filtering the presence information of the plurality of presence entities based on the one or more criteria for determining those presence entities of the plurality of presence entities that match the one or more criteria.

In another aspect, the invention is a Web Service Gateway (WSG) for Presence, comprising:
a watcher interface receiving a request for presence information, the request comprising an indication of one or more criteria associated with presence entities;
a Presence Information Retriever module that retrieves presence information for each one of a plurality of presence entities from a presence server; and
a Filtering module that filters the presence information based on the one or more criteria for determining those presence entities from the plurality of presence entities that match the one or more criteria.

In yet another aspect, the invention is a Presence Server comprising:
a presence database storing presence information related to presence entities;
a service logic module receiving a request for presence information, the request comprising an indication of once or more criteria associated with presence entities;
a Presence Information Retriever module that retrieves from the presence database presence information for each one of the plurality of presence entities; and
a Filtering module that filters the presence information of each one of the plurality of presence entities based on the one or more criteria for determining those presence entities that match the one or more criteria.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a high-level network diagram of a prior art implementation of a Presence functionality;

FIG. 2 is an exemplary high-level network diagram according to a first variant of the preferred embodiment of the present invention;

FIG. 3 is an exemplary high-level network diagram according to a second variant of the preferred embodiment of the present invention;

FIG. 4 is a high-level representation of an exemplary structure of a Subscribe message sent from a watcher according to the preferred embodiment of the present invention;

FIG. 5 is a high-level representation of an exemplary Notify message 260 received by the watcher according to the preferred embodiment of the present invention; and

FIG. 6 is a high-level exemplary flowchart diagram that summarizes the steps of a method for implementing the present invention.

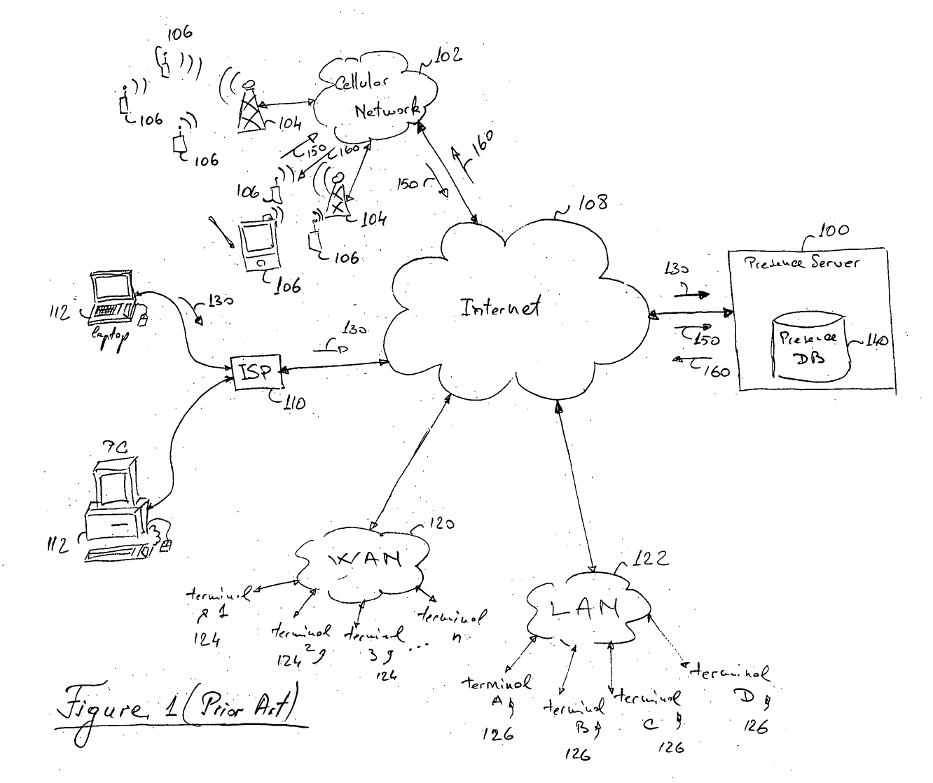

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

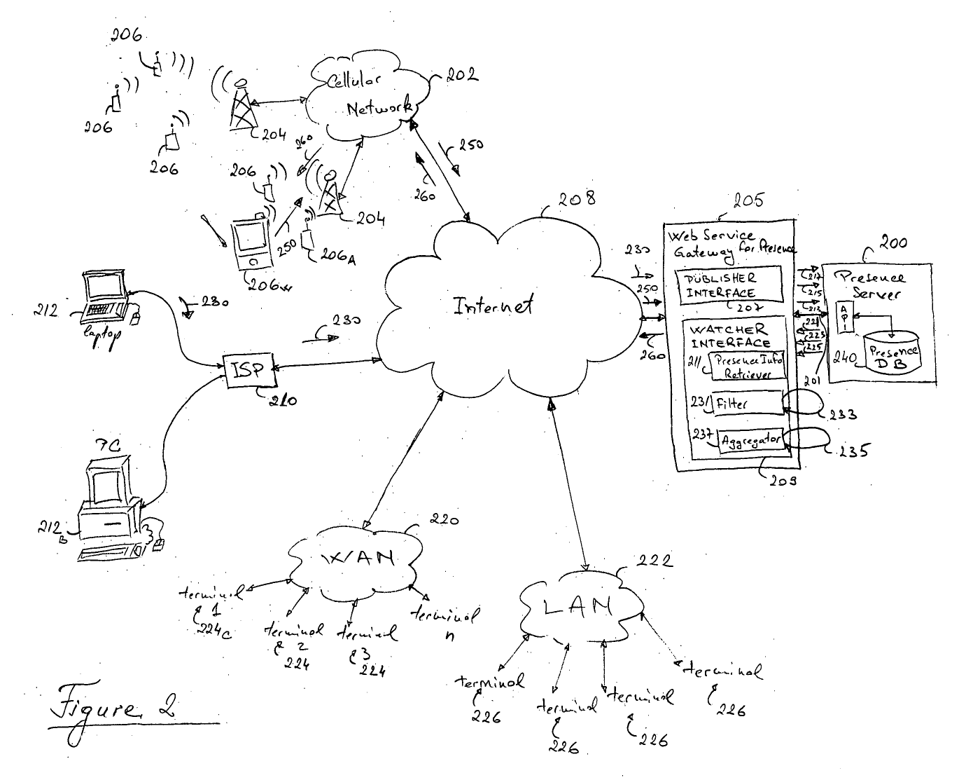

Reference is now made to FIG. 2, which is an exemplary high-level network diagram of a first variant of the preferred embodiment of the present invention, wherein a Presence functionality is implemented via a presence server 200 and a Web Service Gateway (WSG) for presence 205. The WSG for presence 205 is connected to the presence server 200 via communication links 201, and may consist of a standalone node as shown in FIG. 2, or may be a functionality that is co-located with the presence server 200.

Also shown in FIG. 2 is a cellular network 202 that comprises a plurality of base stations 204 that service mobile terminals 206. The cellular network 202 may connect via the Internet 208 to the WSG for presence 205, so that mobile terminals 206 can have access to presence service, i.e. to be able to publish, or to subscribe for receiving presence information. Further represented in FIG. 2 is an Internet Service Provider (ISP) 210 that provides Internet service to a plurality of fixed terminals 212. The ISP 210 is also connected to the WSG for presence 205 via the Internet 208, for allowing fixed terminals 212 to receive presence service. Also connected to the Internet 208 may be one or more Wide Area Networks (WAN) 220 or Local Area Networks (LAN) 222, each serving its respective end-users 224 and 226. The WAN 220 and the LAN 222 are also connected via the Internet 108 to the WSG for presence 205 for enabling user terminals 224 and 226 to be able to receive presence service too. The present architecture wherein a WSG for presence 205 acts as an interface between the users of the presence service and the presence server 200 may be especially useful with existing presence servers, alike the presence server 200, which do not support filtering based on criteria specified by a watcher. Rather, according to the present first variant of the preferred embodiment of the invention, the filtering capabilities are supported by the WSG for presence.

Any one of the end-user terminals 206, 212, 224, and 226 may decide, at one point, to publish presence information about itself. For example the user of the laptop terminal 212 may have subscribed to the presence service provided by presence server 200 and begin to publish presence information about itself, for example using a SIP Publish message 230. The Publish message 230 may be, or comprise an XML file containing presence information about the laptop terminal 212 (the presence entity), as described hereinbefore. The message 230 is sent from the laptop 212 via the ISP 210 and the Internet 208, until it reaches the WSG for presence 205, via a Publisher Interface 207. The Publisher interface 207 relays the Publish message 230 to the presence server 200, which receives the message and stores the presence information in a presence database 240. Because it has subscribed to the presence service and it publishes presence information about itself, the laptop terminal 212 is considered to be a presence entity, also called herein a presentity.

Other presence entities may also publish presence information about themselves, thus populating the presence database 240 of the presence server 200 with presence information. For the purpose of the present invention, it is assumed herein that all terminals shown in FIG. 2 are presentities, thus publishing presence information about themselves.

At one point in time, a watcher may desire to retrieve presence information about a group of presentities that satisfy some particular criteria. For example, a watcher may be interested in obtaining presence information regarding a group of presentities consisting of user A (terminal 206_{A}), user B (terminal 212_{B}) and user C (terminal 224_{C}). However, the watcher only wants to have presence information about those users, among the three users A, B, and C, which terminals support GPRS communications. Or alternatively, the watcher may only be interested in users which connection status is “online”. For the purpose of better understanding the present invention, it is assumed herein that the users A, B, and C have terminals 206_{A}, 212_{B} and 224_{C}, and that the watcher is the user of terminal 206_{W}. Thus, in order to get the desired presence information, the watcher 206_{W} sends a subscription message 250, such as for example a SIP Subscribe message, requesting presence information about presence entities 206_{A}, 212_{B} and 224_{C}, the message comprising the identification of the presence entities, preferably in the form of a telephone number or an email address, and a filter indicative of the criteria desired by the watcher.

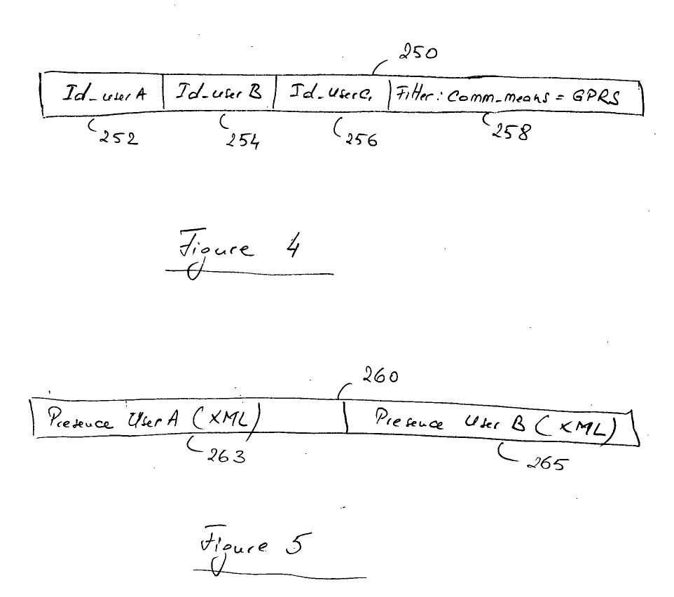

Reference is now made jointly to FIG. 2, and to FIG. 4, which is an exemplary high-level representation of an exemplary subscription message 250, such as a SIP Subscribe message, sent from the watcher 206_{W} in order to request presence information. The Subscribe message 250 comprises identifications 252, 254, and 256 of the presence entities 206_{A}, 212_{B} and 224_{C}, which are of interest for the watcher 206_{W}, as well as one or more filters 258 that indicate which presence entities are of interest for the watcher. In the present case, the watcher is interested in having the presence information of only those presence entities, among the three entities 206_{A}, 212_{B} and 224_{C}, which communications means support GPRS. The filter 258 indicates this preference.

The present variant of the preferred embodiment of the invention provides for a WSG for presence 205, which acts as an interface to a presence server 200. Once the watcher 206_{W} sends the subscription message 250, the message reaches the WSG for presence 205, and is handled by a Watcher Interface 209. A Presence Information Retriever module 211 may extract the identities 252, 254, and 256 of the presence entities 206_{A}, 212_{B} and 224_{C} respectively from the message 250, and send to the presence server 200 individual request messages for presence 213, 215, and 217, wherein each one of these messages requests presence information relative to one of the presence entities 206_{A}, 212_{B} and 224_{C}. The presence server 200 receives the requests 213, 215, and 217, retrieves the appropriate presence information for each one of the presence entities, and responds back with the presence information in messages 221, 223, and 225. The WSG for presence 205 receives the messages 221, 223, and 225 with the presence information relative to each one of the presence entities 206_{A}, 212_{B} and 224_{C}. A Filtering module 231 applies in action 233 the filter 258 on the presence information received in messages 221, 223, and 225, i.e. determines which ones of the presentities 206_{A}, 212_{B} and 224_{C} have a communication means that include GPRS. As a result, the filter module 231 may determine, for example, that only terminals 206_{A} and 212_{B}, but not terminal 224_{C}, are GPRS-capable. In action 235, an Aggregator module 237 aggregates the presence information of terminals 206_{A}, 212_{B} that were determine to match the criteria set by the watcher 206_{W}, and a presence notification message 260, such as for example a SIP Notify message, is returned to the watcher 206_{W} containing the presence information of the matching presentities 206_{A} and 212_{B}.

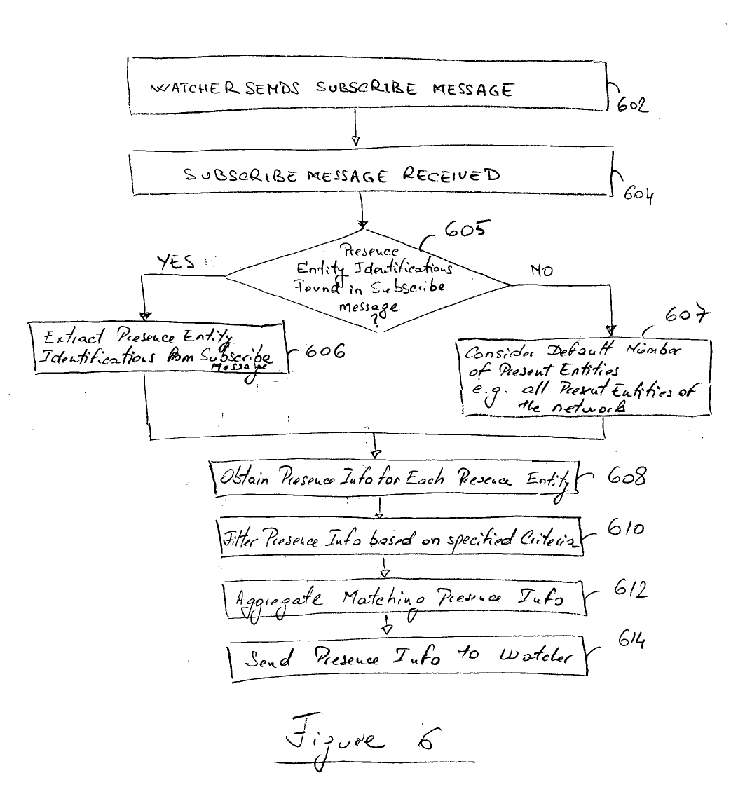

Reference is now made jointly to FIG. 2, and to FIG. 5, which is an exemplary high-level representation of the exemplary Notify message 260. Shown in FIG. 5 is an exemplary notification message 260, such as a SIP Notify message, comprising a first part 263 that contains presence information relative to the user A (terminal 206_{A}), and a second part 265 that contains presence information relative to the user B (terminal 212_{B}). It is possible that the presence information of each user is provided under the form of an XML file, or alternatively, that the presence information of both users is aggregated within a single XML file.

Once the watcher is provided with the identities of the presentities that correspond to its specified criteria, the watcher can take further actions, such as for example sending an advertisement message using GPRS communications to terminals 206_{A} and 212_{B}.

It is understood that any kind of criteria can be specified by a watcher and be used for filtering the presence information relative to a plurality of presentities, as long as the selected attributes values for filtering are supported by the given presence server, including but being not limited to one or more of the following:
presence entity identifier (e.g. sip:professor@university.com, student@college.org);
communication means (e.g. GPRS, WAP, SMS, MM);
connection status (e.g. online, offline, standby, busy)
network status (e.g.: online, offline);
address (e.g.: 514-3452700-2519, person@domain.ca, user@sendsms.com);
priority (e.g.: very high, high, medium, low, very low);
note (e.g.: “I will be at Tokyo next weekend, I will not reply my Emails for the next 2 days”);
User Defined location (e.g.: Montreal, Toronto, Paris, London, Seoul);
Preferred language (e.g.: English, French);
Willingness to communicate (e.g. Unrestricted, Advertisement).

For example, it is foreseeable that a commercial watcher may use a combination of criteria in order to perform a targeted advertisement campaign, and for this purpose may request presence information of only those presence entities which communications means include GPRS, which connection status is online, and which network status is online. Such a filter may have the form as follows:
FILTER (Communication means=GPRS; Connection Status−online; Network Status=online)

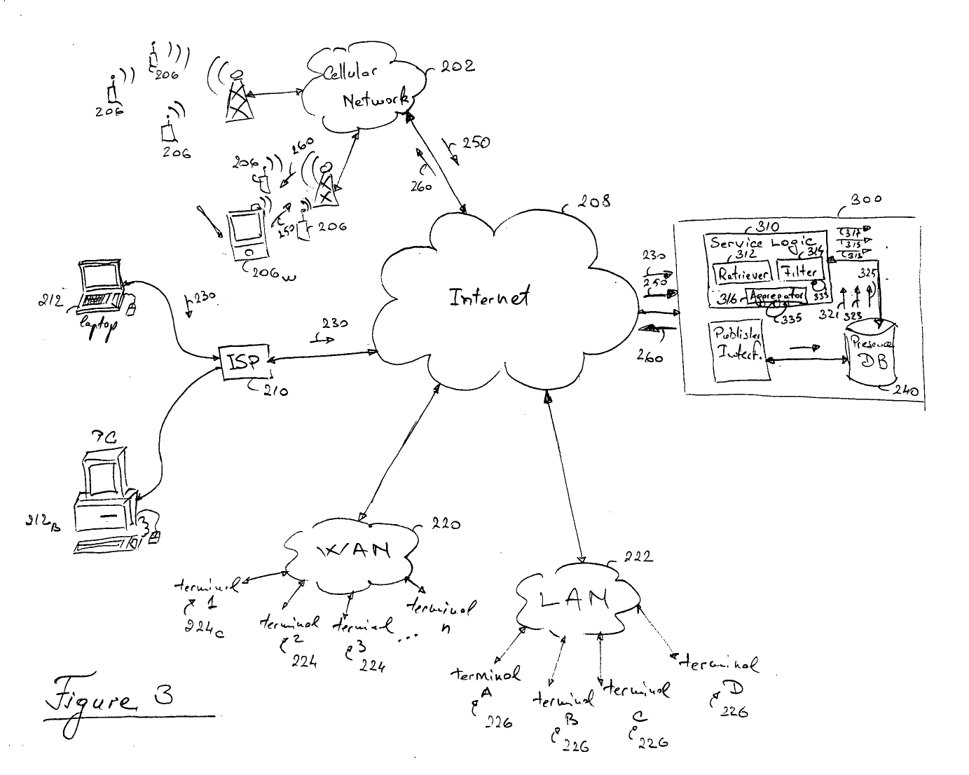

Reference is now made to FIG. 3, which is an exemplary high-level network diagram of a second variant of the preferred embodiment of the present invention, wherein a presence functionality is implemented via a presence server 300 that also comprises filtering capabilities that were described hereinbefore with reference to the WSG for presence 205. In the second variant of the invention represented in FIG. 3, similar elements are designated With identical reference numerals as in the previously described Figures, and thus the presence server 300 is shown as part of the same networks of elements as described with reference to FIG. 2, except for the WSG for presence 205, which is replaced in FIG. 3 by service logic 302 included in the presence server 300 itself. For the purpose of the present exemplary scenario, it is also assumed that all terminals shown in FIG. 3 are presentities, thus publishing presence information about themselves, and wherein the presence information is stored in the presence database 240 of the presence server 300.

The watcher 206_{W} sends a SIP Subscribe message 250 requesting presence information about user terminals 206_{A}, 212_{B} and 224_{C} (the presence entities), the SIP Subscribe message comprising the identification of the presence entities, preferably in the form of a telephone number or an email address, and a filter indicative of the criteria specified by the watcher, in the same manner and for the same purpose as previously described with reference to FIG. 2.

The second variant of the preferred embodiment of the invention provides for a presence server 300 that includes internal service logic for handling a request for presence information that necessitates filtering. Once the watcher 206_{W} sends the Subscribe message 250, the message reaches the presence server 300, and is handled by service logic 310. A Retriever module 312 may extract the identities of the presence entities 206_{A}, 212_{B} and 224_{C} from the message 250, and send to the presence database 240 individual Request messages for presence 313, 315, and 317, wherein each of these message requests presence information relative to one of the presence entities 206_{A}, 212_{B} and 224_{C}. The presence database 240 receives the Requests 213, 215, and 217, retrieves the appropriate presence information for each one of the presence entities, and responds back with the presence information in messages 321, 323, and 325. The service logic 310 receives the messages 321, 323, and 325 with the presence information relative to each one of the presence entities 206_{A}, 212_{B} and 224_{C}. A Filtering module 314 applies in action 333 the filter 258 (received in the Subscribe message 250) on the presence information received in messages 321, 323, and 325, i.e. determines which one of the presentities 206_{A}, 212_{B} and 224_{C} match the criteria specified by the watcher, which in the present exemplary scenario amounts to determine which presentities have a communication means that include GPRS. As a result, the filter module 331 may determine, for example, that only terminals 206_{A} and 212_{B}, but not terminal 224_{C}, are GPRS capable. In action 335, an Aggregator module 316 aggregates the presence information of the matching terminals 206_{A}, 212_{B} that were determined to correspond to the criteria set by the watcher 206_{W}, and a SIP Notify message 260 is returned to the watcher 206_{W} containing the presence information of the presentities 206_{A} and 212_{B}.

Once the watcher 206_{W} is provided with the identities of the presentities that correspond to its desired criteria, the watcher can take further actions as described hereinbefore, such as for example sending an advertisement message using GPRS communications to terminals 206_{A} and 212_{B}.

With reference being further made to FIGS. 3 and 4, it is possible that in some instances the watcher 206_{W} do not specify any list of presentities in the subscription message 250, but rather only one or more criteria for filtering. For example, the watcher 206_{W} may desire to have presence information regarding all presentities that are located in a specific geographical location, e.g. in the west part of the Montreal Island, in Canada. In such an instance, the watcher needs not to specify any identity of presentities in its subscription request message 250, but rather only includes a filter specifying the west part of Montreal:
FILTER (LOCATION=WEST_MONTREAL)

Upon receipt of message 250 with such a filter, the WSG for presence 205, or the presence server 300 returns presence information regarding all registered presentities that match the specified criteria, i.e. which are located in the west part of Montreal, Canada. With reference being made to the first variant of the invention of FIG. 3, this may be achieved by sending from the WSG for presence 205 to the presence server 200 individual request messages for presence, alike requests 213, 215, and 217, for all presentities registered in the network, and receiving back from the presence server 200 presence information related to each one of the registered presentities. Further filtering of the presence information of these presentities is performed by the Filtering module 231 in order to determine those presentities that match the specified criteria, i.e. which are located in the west part of Montreal, Canada. The presence information of the matching presentities is returned in message 260, or in a suite of messages alike message 260, to the watcher.

With reference being now made to FIG. 4, when a watcher sends the Subscribe message 250 without any list of presentities, the fields 252, 254, and 256 of the message 250 are empty, or blank, while the filtering criteria 258 is present within the message.

Reference is now made to FIG. 6, which is an exemplary high-level flowchart diagram that summarizes the steps of a method for implementing the present invention. In action 602, a watcher, which is interested in having presence information regarding a plurality of presentities, sends a Subscribe message comprising an indication of criteria (or only one criterion) for filtering the presentities. The Subscribe message may also optionally comprise a list of presentities in which presence information the watcher is interested. In action 604, the presence functionality receives the Subscribe message. The presence functionality may comprise a presence server, and optionally a WSG for presence as described hereinbefore. In action 605 it is determined if presentities identifications are present in the Subscribe message 250. If so, in action 606, the identifications of the presentities of interest are extracted from the Subscribe message, so that presence information may be requested for these presentities. Otherwise, if the Subscribe message does not comprise any identification of presentities, in action 607 it is concluded that presence information should be requested for a default value of presentities, which may be set according to network operator's preferences, and may for example include all presentities of the given network, or a pre-determined portion thereof. In action 608, the presence information associated with the presentities of interest is obtained from the presence database of the presence functionality. Further in action 610, the presence information is filtered based on the criteria specified in the Subscribe message by the watcher in order to identify those presentities that correspond to the desired criteria. In action 612, which is optional, the presence information of the presentitites that match the desired criteria is aggregated, and is sent in action 614 to the watcher, preferably via a Notify message.

The implementation of the presence invention within the WSG for presence and the presence server may be made using any software and/or hardware modules, or any combination thereof. For example, the WSG for presence and the presence server may be UNIX-based computer systems that run a software application implementing the present invention.

Therefore, with the present invention it becomes possible to request presence information about a plurality of presentities, to specify one or more criteria for the presentities of interest, and to get back the presence information of those presentitites that match the specified criteria.

Based upon the foregoing, it should now be apparent to those of ordinary skills in the art that the present invention provides an advantageous solution, which provides a method, WSG for presence and presence server for retrieving presence information relative to a plurality of presentities based on criteria associated with the presentities of interest. Although the system and method of the present invention have been described in particular reference to certain exemplary type of networks, it should be realized upon reference hereto that the innovative teachings contained herein are not necessarily limited thereto and may be implemented advantageously any communications networks, using various communications protocols. However, preferably, the signaling for requesting and obtaining presence information may be based on SIP and/or SIMPLE protocols. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for obtaining presence information comprising the steps of:
a. receiving a request for presence information, the request comprising an indication of one or more criteria associated with presence entities;
b. retrieving presence information for each one of a plurality of presence entities; and
c. filtering the presence information of the plurality of presence entities based on the one or more criteria for determining those presence entities of the plurality of presence entities that match the one or more criteria.

2. The method claimed in claim 1, further comprising the step of:
d. responsive to the request, sending to a watcher a response message comprising the presence information of those presence entities that match the one or more criteria.

3. The method claimed in claim 1, wherein the request further comprises identifications of each one of the plurality of presence entities.

4. The method claimed in claim 1, wherein the plurality of presence entities corresponds to a default value.

5. The method claimed in claim 2, wherein the request comprises a subscription message and the response message comprises a notification message.

6. The method claimed in claim 2, wherein the response message comprise an XML file containing presence information of those presence entities that match the one or more criteria.

7. The method claimed in claim 2, wherein:
step a. comprises the step of:
a.1. receiving the request at a Web Service Gateway (WSG) for presence;
step b. comprises the step of:
b.1 retrieving from a presence database of a presence server, by a presence Information Retriever module of the WSG for presence, presence information of each one of the presence entities of the plurality of presence entities;
step c. comprises the step of:
c.1 filtering by a filtering module of the WSG for presence the presence information based on the one or more criteria for determining those presence entities that match the one or more criteria.

8. The method claimed in claim 2, wherein:
step a. comprises the step of:
a.1. receiving the request at a service logic of a presence server;
step b. comprises the step of:
b.1 retrieving by a presence Information Retriever module of the service logic the presence information for each one of the presence entities of the plurality of presence entities from a presence database of a presence server;
step c. comprises the step of:
c.1 filtering by a filtering module of the service logic the presence information based on the one or more criteria for determining those presence entities that match the one or more criteria.

9. The method claimed in claim 1, further comprising prior to step a. the steps of:
d. receiving presence information from each one of the plurality of presence entities; and
e. storing the presence information received from each one of the plurality of presence entities in a presence database.

10. A Web Service Gateway (WSG) for presence, comprising:
a watcher interface receiving a request for presence information, the request comprising an indication of one or more criteria associated with presence entities;
a presence Information Retriever module that retrieves presence information for each one of a plurality of presence entities from a presence server; and
a Filtering module that filters the presence information based on the one or more criteria for determining those presence entities from the plurality of presence entities that match the one or more criteria.

11. The WSG for presence claimed in claim 10, wherein responsive to the request, the watcher interface sends to a watcher a response message comprising the presence information of those presence entities that match the one or more criteria.

12. The method claimed in claim 10, wherein the request further comprises identifications of each one of the plurality of presence entities.

13. The method claimed in claim 10, wherein the plurality of presence entities corresponds to a default value.

14. The WSG for presence claimed in claim 11, wherein the request comprises a subscription message and the response message comprises a notification message.

15. The WSG for presence claimed in claim 11, wherein the response message comprise an XML file containing the presence information of those presence entities that match the one or more criteria.

16. A presence server comprising:
a presence database storing presence information related to presence entities;
a service logic module receiving a request for presence information, the request comprising an indication of once or more criteria associated with presence entities;
a presence Information Retriever module that retrieves from the presence database presence information for each one of the plurality of presence entities; and
a Filtering module that filters the presence information of each one of the plurality of presence entities based on the one or more criteria for determining those presence entities that match the one or more criteria.

17. The presence server claimed in claim 16, wherein the presence Information Retriever module and the Filtering module are comprised in the service logic module.

18. The presence server claimed in claim 16, wherein the request further comprises identifications of each one of the plurality of presence entities.

19. The method claimed in claim 16, wherein the plurality of presence entities corresponds to a default value.

20. The presence server claimed in claim 16, wherein the Presence Information Retriever module sends individual requests for presence information to the presence database for each one of the plurality of presence entities, and gets back from the presence database presence information relative to each one of the plurality of presence entities.
